(19) United States
(12) Patent Application Publication
(10) Pub. No.: US 2004/0098703 A1
(43) Pub. Date: May 20, 2004

(54) Integration of multiple software tools under a single site

(76) Inventor: Sankar Narayana Kondur, Woodbridge, NJ (US)

Correspondence Address: JEFFREY FURR, 253 N. MAIN STREET, JOHNSTOWN, OH, 43031, US

(21) Appl. No.: 10/065,749

(22) Filed: Nov. 15, 2002

(51) Int. Cl. G06F 9/44; G06F 17/30; G06F 15/16

(52) U.S. Cl. 717/100; 707/10; 709/203

(57) ABSTRACT

The invention is an integration of development tools functionality—source code management, compilation, running etc on the server side. The invention is centralized. The way the existing invention works is that different tools provide different features for the various things the developer needs to do. It's a single product giving the functionality of different tools. The main components are Account, Users manager, Project manager, Source code compilation and run-time management, Repository Manager, Datasource Manager, J2EE Center, The Requirements and Analysis center, The DrawBoard, Productivity Wizards, and The NCStudio client.

### BACKGROUND OF INVENTION

1. Field of the Invention

This invention relates to the art of software development tools and more specifically an integration of multiple software tools under a single site.

2. Description of Prior Art

Though software development tools have been there for years—none of them do the source code management, compilation, running etc on the server side. They don't provide Intelligent Integration of the components a developer needs to do build an application—source code, libraries, application requirements, UML diagrams, database, application servers etc.

Many of these current tools are for a desktop only and are not server based.

U.S. Pat. No. 6,457,170 is a method and apparatus for building a software system in a networked software development environment, utilizing existing software version control and build tools such as RCS and MAKE. Source and object files are loaded into network caches shared by multiple users at local workstations.

U.S. Pat. No. 6,256,774 is for methods, systems, and computer program products to centrally manage references to objects recently employed by a user operating in a software development environment. After transmission of collection messages to plural applications, a receiver centrally managing object references receives an information block of object references. A writer of the centrally managing object references system writes the information blocks into memory. A reader further reads previously written information blocks to inform plural applications of what objects were previously referenced.

U.S. Pat. No. 6,41 2,055 is a method and apparatus for allowing developers to develop software for their product. The method includes providing a first mode signal to a processor to operate in a development mode. The method also includes executing instructions stored in a first region of the memory in response to the first mode signal, providing data to the processor, and writing the data into a second region of the memory.

U.S. Pat. No. 6,058,393 is for a dynamic connection for distributed applications that need to locate application development tools, including but not limited to debuggers, trace collection tools, compilers, etc. which may be running on different machines, and to send the tools messages. The program requesting debugging service (i.e., a debugger client) sends, to a tool locator, criteria which specifies the properties of a desired debugger. The tool locator maintains a registry of all tools, e.g. debuggers, and their properties, which remain active within the network by receiving tool registration information from each tool as it is started on any machine within the network.

U.S. Pat. No. 6,003,143 is a computer system, an improved tool and method for debugging complex computer programs. The tool extracts critical debugging information from computer memory and/or remote storage memory and uses this information to graphically depict call relationships among various functions comprising the program which is the subject of the debugging operation. Debug commands are accepted by the tool through a graphical user interface using operations performed by the user directly on the graphical representation of program functions. The ability of the tool to accept user commands through the graphical user interface and to display critical debugging information using this same interface greatly facilitates program debugging.

U.S. Pat. No. 5,767,848 is a development support system for supporting new product development activities including designing, manufacturing experimental models and testing the functions of the experimental models and for providing an environment for the cooperative activities of a plurality of members of a development project team. It has a model storage for storing product models, resource models of resources to be used for product development and product development activity models, a target storage for storing target values of schedules of product development and the cost and the performance of the product, an estimating unit for estimating schedules of product development and the cost and the performance of the product on the basis of the models stored in the model storage, a support unit for supporting the operations of the members of the development project team for making reference to the models, the target values and the estimated values, and changing and particularizing the models, the target values and the estimated values, a notifying unit for deciding, when each model is changed or particularized, whether or not the estimated values meet the corresponding target values and, when the estimated values do not meet the corresponding target values, for notifying the members of the development project team to that effects; and a unit for monitoring electronic mail necessary for carrying out tasks essential to the development of the product, extracting information relating to the progress of tasks essential to carrying out the development of the product, and providing the members of the development project team with information about the progress of the tasks.

The need for a method for having a software development tool that can do the source code management, compilation, and running on the server side shows that there is still room for improvement within the art.

### SUMMARY OF INVENTION

The object of the current invention is an integration of development tools functionality—source code management, compilation, running, etc. on the server side.

While the previous tools are desktop based, the current invention is centralized. The way the existing invention works is that different tools provide different features for the various things the developer needs to do. It's a single product giving the functionality of different tools.

The main components of the current invention are.

1. Account, Users manager,

2. Project manager,

3. Source code compilation and run-time management,

4. Repository Manager,

5. Datasource Manager,

6. J2EE Center,

7. The Requirements and Analysis center,

8. The DrawBoard,

9. Productivity Wizards, and

10. The NCStudio client.

### BRIEF DESCRIPTION OF DRAWINGS

Without restricting the full scope of this invention, the preferred form of this invention is illustrated in the following drawings:

FIG. 1 shows an overview of the system 1;

FIG. 2 shows overview of System Architecture; and

FIG. 3 shows an overview of Password Key Templates.

### DETAILED DESCRIPTION

The preferred embodiment of the invention is a process that is an integration of development tools functionality—source code management, compilation, running etc on the server side.

The System 1 is an integration of development tools functionality—source code management, compilation, running etc that is designed to run on the server side of a computer network.

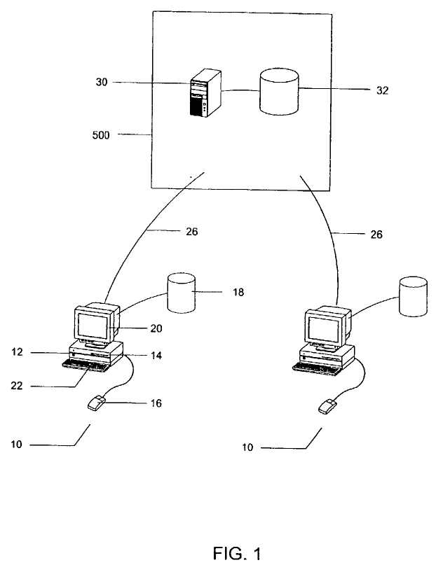

FIG. 1 shows a typical software development workstation 10 suitable for practicing the present invention. As shown in FIG. 1, the workstation 10 comprises a monitor 20 and keyboard 22, a computer processing unit 12, and various peripheral interface devices that might include a floppy drive 14 and a mouse 16 Workstation 10 further includes memory 18 that further includes internal local cache memory (not shown in FIG. 1), and a network interface 26 that interfaces the workstation to a number of other workstations, external storage 32, and other external computing resources. Although the present invention can be practiced on a standalone workstation that is not networked to other computer workstations or to other network components, the capabilities of the present invention are best realized in a software development environment that comprises a number of software development computer workstations 10 networked to a central server 30 and a storage medium 32 that includes a certain amount of quickly accessible electronic storage, such as random access memory (RAM), as shown in FIG. 1.

The central server 30 and storage medium 32 includes a file server, a software library archive that is managed by a software configuration control system such as RCS, and one or more network cache memories that can be quickly accessed by all workstations on the network. For the purposes of this disclosure, cache memory that is internal to each local workstation on the network is referred to as “local cache memory” or “local cache.” The term “network cache memory” or “network cache” refers to the electronic memory 32 located on the network which is quickly accessible by each local workstation on the network. In this disclosure, the present invention is described as being practiced in this development environment. Notwithstanding the above description of the software development environment, one skilled in the art will recognize that the present invention can be practiced upon any of the well known specific physical configurations of standalone or networked software development workstations, using any of the well known software configuration management systems wherein software items are archived and maintained under a configuration or version control system.

The system 1 has numerous components that are situated on Server Side 30. The main components are

a. Account, Users manager. This component manages the group, the users in the group, and the functionality related to groups and users. Some of the functionality includes adding/deleting accounts, adding/deleting users to accounts, modifying the user information. The information is stored in a RDBMs. It also maintains the account and user directories.

b. Project manager. This component manages the Projects, its components and their related functionality. The components in a project include Directories, Files, Packages etc. The functionality includes but is not limited to managing the projects' properties, adding/deleting projects, directories, files, including packages into a project and other project related activities.

c. Source code compilation and run-time management. This component manages the source code, its compilation and running. It has logic to get the location of the specific source code and compile it and also to get the specific machine/byte code and run it.

d. Repository Manager. This component manages the java packages, projects and other resources in the account and its related activities. It provides a store/repository kind of functionality. It stores the packages, projects and other resources in the repository.

e. Datasource Manager. This component manages the databases, database accounts, and other databases related functionality for the users. Some of the functionality it has is (1) create, delete and modify datasources, (2) create, modify and delete database accounts in these datasources (3) login and access and manipulate the data in these database accounts.

f. J2EE Center. This component handles the J2EE/Webservices related functionality for the user 10. This functionality includes but is not limited to create, modify, delete, deploy various J2EE components like EJB Jar, WAR and EAR.

g. The Requirements and Analysis center. This component provides the Requirements and Analysis functionality for a project. This functionality includes but is not limited to letting the user describe the requirements, add/delete/modify requirements, analyze and design the project.

h. The DrawBoard. This component lets the users draw the screens of the application in an easy way.

i. Productivity Wizards. These are a collection of components that let the user create parts of his application in an easy way. They are smart and know various resources the user is using for his development application code, databases, application servers etc.

All these components on the server side are aware of each other and require the help of other components to do their work.

The server side components are programmed in the Java language. And by the nature of Java language, they can be run on different Oses without modification.

How the server side components interact? Among the server side components, some are very basic and needed for others to work and whereas some of the components are needed for a specific functionality. The AccountManager, UserManager, ProjectManager are core components that are required by other components to access the resources required.

Client Side: j. The NCStudio client 40. This is a client side component that the developers use to interact with the server side components. For each server side component, the client provides a corresponding components to interact with it.

The client side component and the server side component interact using HTTP protocol or RMI protocol or SOAP protocol or any other protocol that can be used to communicate between two remote services. The server side components interact with each other using simple function calls or any other protocol used by remote services.

The client is written in the Java language. It can also be written in Visual C++, Visual Basic or C#. If the client language is different from the server components, the preferred communication is through SOAP.

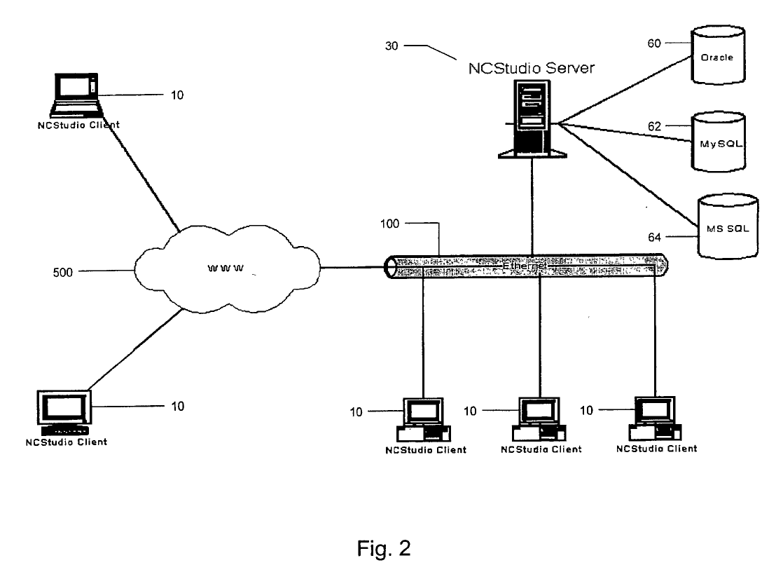

FIG. 2 shows some of the typical means that a user/workstation 10 connects to the central server 30. A user 10 can access the central server through World Wide Web 500. Accessing the central server 30 can be accomplished directly through a communication means such as a local Internet Service Provider, often referred to as ISPs, or through an on-line service provider like CompuServe, Prodigy, American Online, etc.

The Users 10 contact the central server 30 using an informational processing system capable of running an HTML compliant Web browser such as Microsoft's Internet Explorer, Netscape Navigator, Lynx or Mosaic. A typical system that is used is a personal computer with an operating system such as Windows 95, 98 or ME or Linus, running a Web browser. The exact hardware configuration of computer used by the Users 10, the brand of operating system or the brand of Web browser configuration is unimportant to understand this present invention. Those skilled in the art can conclude that any HTML (Hyper Text Markup Language) compatible Web browser is within the true spirit of this invention and the scope of the claims.

The users 10 can also access the central server 30 through a LAN or WAN using an Ethernet 100.

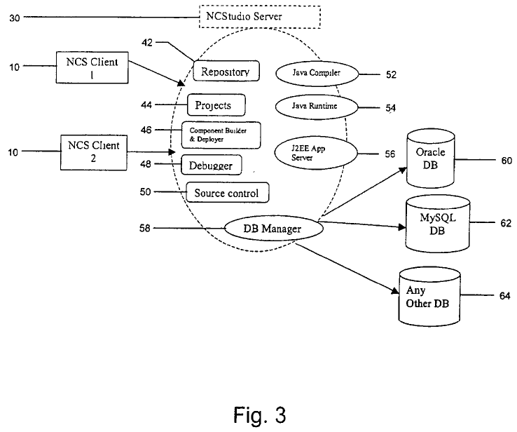

FIG. 3 shows the base interaction between the components. The Users 10 contact the central server 30. The workstations 10 have the NCStudio Client component 40. The Client component 40 is used to interact with the server side components.

The central 30 has the following components contained on it within its memory and being able to be run by the workstation 10, the repository 42, Projects 44, component builder and deployer 46, debugger 48, source control 50, java compiler 52, java runtime 54, J2EE application server 56 and DB Manager 58.

DB Manager 58 manages the databases used by the system 1. It manages the Oracle DB 60, MySQL DB 62 and any other DB 64.

Advantages The previously described version of the present invention has many advantages, including many elements missing in all prior art. It provides a centralized tool structure. It has the different tools that provide different features for the various things the developer needs to do. It's a single product giving the functionality of different tools.

Although the present invention has been described in considerable detail with reference to certain preferred versions thereof, other versions are possible. For example, the functionality and look of the web site could use different or new protocols or an Intranet could be used. Therefore, the point and scope of the appended claims should not be limited to the description of the preferred versions contained herein.

That which is claimed is:

1. A system for software development comprising:
a client side component;
a client system connecting to a server system, and
a plurality of server side components.

2. A system according to claim 1 in which the server side components includes:
an Account and Users manager,
a Project manager,
a Source code compilation and run-time management,
a Repository Manager,
a Datasource Manager,
aJ2EE Center,
a Requirements and Analysis center,
a DrawBoard, and
a Productivity Wizard.

3. A system according to claim 1 in which the client side connects to the server system using a LAN.

4. A system according to claim 1 in which the client side connects to the server system using a WAN.

5. A system according to claim 1 in which the client side connects to the server system using an Ethernet connection.

6. A system according to claim 1 in which the datasource manager manages an oracle database and a plurality of SQL databases.
